(19) United States
(12) Patent Application Publication
(10) Pub. No.: US 2025/0314462 A1
(43) Pub. Date: Oct. 9, 2025

(54) MODULAR MARITIME DEPLOYMENT SYSTEM FOR MULTIFUNCTIONAL SUBSURFACE AND SURFACE OPERATIONS

(71) Applicant: ULTRASEA, INC., East Kingston, NH (US)

(72) Inventors: Judson DeCew, East Kingston, NH (US); Michael J. Osienski, Londonderry, NH (US)

(73) Assignee: ULTRASEA, INC., East Kingston, NH (US)

(21) Appl. No.: 19/089,585

(22) Filed: Mar. 25, 2025

Related U.S. Application Data
(60) Provisional application No. 63/575,419, filed on Apr. 5, 2024.

(51) Int. Cl. F41H 11/05; A01K 61/60; E02B 15/08

(52) U.S. Cl. CPC F41H 11/05; A01K 61/60; E02B 15/0814

(57) ABSTRACT

A modular maritime deployment system designed for multifunctional subsurface and surface operations, addressing a wide spectrum of maritime needs. This innovative system provides a comprehensive solution adaptable for both security applications, such as countering Uncrewed Underwater Vehicle (UUV) threats, and commercial operations, including marine cultivation and environmental monitoring. The system's modular design facilitates easy assembly, reconfiguration, and scalability to support various applications, ranging from deploying security barriers to optimizing conditions for the growth of seaweed, algae, and shellfish. It features components capable of deploying acoustic dampening materials, blast panels, and electromagnetic shielding, enhancing the versatility and utility of the system in diverse maritime environments. Integrated with advanced sensors and automated deployment mechanisms, the system ensures effective deployment and management of both surface and subsurface devices, making it an indispensable tool for modern maritime operations across commercial and security sectors.

### RELATED APPLICATIONS

This application claims the benefit of U.S. Provisional Patent Application No. 63/575,419, filed on Apr. 5, 2024, which is herein incorporated by reference in its entirety.

### TECHNICAL FIELD

The present disclosure relates to maritime deployment systems, specifically to modular, scalable systems designed for versatile marine applications. This disclosure pertains to a floating and subsurface deployment system engineered to support a wide range of marine activities, including but not limited to, a deployable barrier system designed to counter Uncrewed Underwater Vehicle (UUV) threats, the deployment of acoustic mitigation materials, electromagnetic shielding materials, passive and active blast panels, and the cultivation of seaweed, algae, shellfish and other marine organisms. The system is designed to be easily shipped, assembled, deployed, and recovered, offering significant advantages in terms of flexibility, environmental sustainability, and adaptability to various maritime operational needs.

### BACKGROUND

The increasing use of Unmanned Underwater Vehicles (UUVs) for both civilian and military purposes presents new challenges for maritime security. Traditional marine barriers, while effective against surface threats as seen in patents, for example, US patents RE40,616; U.S. Pat. Nos. 7,401,565; 9,121,153B2 and US Pub. 2008/0105184, often lack the flexibility and adaptability required to counter subsurface threats effectively. Subsurface nets have been proposed as a countermeasure (see patents U.S. Pat. Nos. 8,537,011 B2, 8,928,480 B2, US 2015/0294541 A1), but these systems, such as fiber optic nets, are typically permanently deployed, which limits their flexibility and adaptability and do not address the broader spectrum of potential underwater threats.

Most current countermeasure products concentrate on sensors that detect and track UUVs. Devices are being developed to deploy entanglement lines and nets from manned vessels or uncrewed surface vehicles. Historically, submarine nets have been used in waterways to protect against submarines and torpedoes, but these systems require significant maintenance due to cleaning, removal for vessel access, and other factors. Additionally, these systems are expensive and designed to capture large and fast subsurface vehicles.

In modern maritime operations, there is also a growing need for deploying specialized materials for various protective and environmental purposes. Acoustic dampening materials are increasingly important in reducing noise pollution that affects marine life and can mask the presence of submarines or other stealthy vehicles. Blast panels are vital in protecting against underwater explosions, either accidental or from hostile actions, providing an additional layer of security for critical infrastructure. Electromagnetic shielding is crucial for protecting sensitive equipment from external electromagnetic interference, which can be particularly disruptive in a marine setting.

Moreover, the strategic deployment of marine structures can significantly benefit marine species, particularly those cultivated for commercial purposes such as seaweed, algae, and shellfish. These species often exhibit increased growth rates when positioned dynamically within the water column, where water flow, light, and nutrient levels are most favorable. Implementing a system that enables adjustment of the depth of cultivation units dynamically could revolutionize marine farming by maximizing growth conditions and minimizing environmental stressors.

Therefore, there is a pressing need for a more versatile and environmentally friendly solution that not only enhances dynamically reconfigurable maritime security against a range of threats but also supports ecological and commercial objectives. Unlike conventional systems that are either permanently deployed or manually retrieved, a system that allows for controlled deployment and retraction, and precise positioning at any point within the water column or full retraction out of the water when not in use would significantly reduce maintenance, prevent unnecessary environmental disruption, and enhance adaptability for various operational needs. A modular, scalable deployment system that can be retracted or repositioned as required—while minimizing environmental impact—would represent a significant advancement in the field of maritime technology.

### SUMMARY

The present disclosure introduces a marine deployment system that can be utilized as a barrier, among other applications, to address the increasing challenges posed by Uncrewed Underwater Vehicles (UUVs) and other maritime threats. This system offers a comprehensive and scalable solution, providing protection both above and below the water surface. In embodiments, the system functions effectively as a barrier system when assembled in specific configurations and is designed to counter UUV threats with a deployable underwater net, ensuring defense across the full water column (defined as the vertical expanse of water extending from the surface to the seafloor at a given location), with minimal environmental impact.

When configured as a barrier system, this technology advances the state of the art by integrating a counter-UUV net that is stored out of the water, thereby reducing maintenance requirements and minimizing wildlife concerns.

This system is not limited to functioning solely as a security barrier. The system is designed with the flexibility to support a variety of other applications. In embodiments such applications include the deployment of acoustic dampening materials to mitigate underwater noise pollution, blast panels for protection against explosions, and electromagnetic shielding to safeguard sensitive equipment. The modular nature of the system allows for easy adaptation and reconfiguration to meet these diverse needs without requiring extensive modifications.

Moreover, in embodiments the system enhances marine cultivation by providing adjustable deployment platforms for cultivation of seaweed, algae, and shellfish. By enabling precise and dynamically adjustable positioning within the water column, the system helps optimize environmental conditions for growth, thereby improving yield and health of these species. This capability makes such a system an invaluable tool for marine agriculture, offering benefits that extend beyond security and environmental protection.

In addition to these features, in embodiments the system integrates advanced sensors and deployment mechanisms, such as winches and acoustic releases, timed releases, galvanic releases, ROV/AUV-actuated releases, radio-controlled releases, and other types of remote controlled releases, to facilitate the dynamic deployment of nets, booms, and other devices. Whether for containing oil spills, deploying counter-UUV devices, or supporting marine life, the system's versatility in deployment options underscores its utility in modern maritime operations.

In embodiments configured as a security or safety barrier, the above water net system may be mounted on dual compliant stanchions, which allow the modules to move freely, reducing wear and maintenance requirements. Unlike other compliant net support systems (such as patent that shown in US patent U.S. Pat. No. 11,414,165B2), the dual compliant stanchions in this disclosure are designed to be flexible in both directions parallel and perpendicular to the barrier's axis. This design enables the net to deform and engage an impacting vessel if needed, while also mitigating environmentally induced loads on the system.

In embodiments, the security barrier configuration may support various types of subsurface barriers, including standard polymer nets, monofilament nets, and metal nets, which may be flexible, rigid, or semirigid. A ballast framework may be provided, which serves both to provide a ballast force in the downward direction and to support the net when in a retracted position. In embodiments this ballast framework is modular, allowing for the weight of the ballast to be adjusted based on the weight of the net and in consideration of the hydrodynamics of the barrier system. The ballast framework provides downward force to assist in deployment and stabilization of the deployable member when stored or deployed.

Embodiments of the disclosed security barrier may include compatibility with commercial off-the-shelf capture nets for both above and below water use, out-of-water storage of the subsurface net or other deployable member, and versatile deployment options, such as manual or automatic deployment using standard technologies like winches, acoustic releases, and exploding bolts. Additionally, in embodiments the system integrates an oil containment system, providing oil spill response capabilities if needed.

The objects and advantages of the disclosed subject matter will be further detailed in the following sections, alongside accompanying drawings. The various configurations and deployment options discussed may be performed in different orders or simultaneously with each other, showcasing the system's adaptability to diverse maritime security needs.

Note that the claims appended hereto are not to be interpreted as limiting the scope of this disclosure, but rather are provided as explanatory material for possible embodiments.

One embodiment provides a marine barrier system comprising: a series of flotation modules configured to provide buoyancy and structural support; dual tethers configured to connect between the flotation modules along a centerline; compliant stanchions, mounted on the flotation modules, configured to support an above water capture net; and a deployable member stored out of the water and extendable toward the seafloor.

In another embodiment the maximum extent to which the deployable member is extended is adjustable.

A further embodiment comprises a ballast framework configured to provide a negative vertical force to draw the deployable member into the water and to support the deployable member when stored out of the water.

Yet another embodiment comprises a winch system for deploying and recovering the deployable member, said winch system mounted to the flotation modules and connected to lines running through the modules and around the ballast framework.

In a yet further embodiment, the dual tethers are secured to the flotation modules using locking clamps.

In still another embodiment, the deployable member is a net configured to counter an uncrewed underwater vehicle (UUV) threats.

In a still further embodiment, the deployable member is a substantially continuous member configured to contain or abate oil.

Even another embodiment further comprises a sensor for automatic deployment of the deployable member upon detection of security or environmental threats, the sensor comprising a hydrophone, a sonar system, or another detection system.

In an even further embodiment, the deployable member comprises a counter-UUV device selected from the group consisting of entanglement lines, individual net panels, ballast components, and interdiction devices.

In an even further embodiment, the deployable member comprises a material selected to provide acoustic shielding and/or electro-magnetic protection, comprising a semi-rigid or flexible panel such as of a dense flexible material (such as a neoprene or rubber sheet), an anechoic coating, an open or closed cell foam or wire mesh, a carbon loaded foam, a conductive coating, and/or a coated faraday cage material.

In an even yet further embodiment, the deployable member comprises a material selected to provide subsurface blast protection, such as commercial off-the-shelf Energetic Reactive Armor (ERA) or Non-Energetic Reactive Armor (NERA).

A still even further embodiment provides a method for protecting maritime assets from surface and subsurface threats using a marine barrier system, comprising: storing, above the waterline, in a flotation module that is a structural member of the marine barrier system, a deployable member that is configured to provide protection against a UUV device; and deploying said deployable toward the seafloor upon detection of a threat.

In a still even further embodiment, the compliant stanchions are fabricated from compliant materials such as pultruded composite or carbon fiber, allowing the posts to flex and twist under environmental forces, thereby reducing stress on the net capture system.

In still yet another embodiment, the deployable member is a debris boom or a silt barrier.

In a still yet further embodiment, the deployable member and above water capture system are modular and configurable to accommodate different types of threats and environmental conditions, allowing for customization and adaptability of the barrier system.

Even yet another embodiment comprises an integrated sensor network for real-time monitoring of the marine environment and automatic detection of threats, the sensor network being capable of communicating with the barrier system to trigger deployment of countermeasures.

An even yet further embodiment comprises a plurality of types of deployable members, configured so as to be deployed independently of each other.

A still even yet another embodiment comprises a marine deployment and recovery mechanism.

A still even yet further embodiment provides a method for deploying a marine barrier system comprising: positioning a series of flotation modules to form a barrier structure; connecting the flotation modules with dual tethers; mounting compliant stanchions on the flotation modules; suspending an above water capture net between the compliant stanchions; and deploying a subsurface net from a stored position above water to a deployed position extending to the seafloor, wherein: the deployment of the subsurface net is controlled by a deployment mechanism that is integrated into the flotation modules.

In yet still even another embodiment, the barrier system supports gate operations by enabling the subsurface net to be raised either partially or fully out of the water, facilitating access or passage through the barrier while maintaining security against subsurface threats.

A yet still even further embodiment comprises a bubble screen system that is integrated into the barrier system and can be activated to create a column of bubbles configured so as to disrupt navigation and detection systems of approaching underwater threats.

A yet further still embodiment comprises an aquaculture support structure configured to protect, support, and/or contain a marine species, the marine deployment and recovery mechanism configured to adjustably position the aquaculture support structure within a water column.

One embodiment of a modular maritime deployment system comprises: a plurality of flotation modules, each configured to provide buoyancy and structural support, connected together to form a floating support structure; a deployable member, attached to at least one of the flotation modules, configured to be stowable in a retracted position and to be extendable downward into a deployed position; and a deploying/retracting mechanism mounted on a flotation module, configured to control deployment and retraction of the deployable member between the retracted position and the deployed position; wherein the deployed position in respect to the deploying/retracting mechanism is determined by a deployed length by which the deployable member is extended by that deploying/retracting mechanism or by the water column depth.

Another embodiment provides such a system, wherein the retracted position is such that at least a portion of the deployable member is above a waterline.

A further embodiment provides such a system, wherein the deploying/retracting mechanism comprises a reel configured to wind or unwind simultaneously dual tendons that are attached to the deployable member.

Yet another embodiment provides such a system, further comprising a dual tether, connecting at least some of the plurality of the flotation modules, secured to each of the connected floating modules using locking clamps.

A yet further embodiment provides such a system, further comprising a local control system configured to adjust automatically a deployed length or a tension of the deployable member in response to a bathymetry and/or tidal condition.

Still another embodiment provides such a system, wherein the deployable member is a bubble screen generator.

A still further embodiment provides such a system, wherein the deployable member comprises one or more selectively actuatable sections, wherein each section can be independently raised, lowered, or retracted.

Even another embodiment provides such a system, wherein the deployable member is a deployable barrier member.

An even further embodiment provides such a system, wherein the deployable barrier member is configured so as to be supported by the deploying/retracting mechanisms of a plurality of the flotation modules.

A still even another embodiment provides such a system, wherein the deployable barrier member is configured so as to enable a length of extension of one portion of the deployable barrier to differ from a length of extension of another portion of the deployable barrier member.

A still even further embodiment provides such a system, wherein the deployable barrier member is configured as an environmental response barrier.

Still yet another embodiment provides such a system, wherein the deployable barrier member is configured as an expeditionary net pen.

A still yet further embodiment provides such a system, further comprising a flexible net post, positioned on or atop an aforementioned flotation module, the net post extending upward and supporting an above-water net, wherein the net post comprises a resilient material and is configured to bend under wave action or impact.

Even yet another embodiment provides such a system, wherein the deployable member comprises a ballast framework.

An even yet further embodiment provides such a system, wherein the deployable member comprises an interdiction system or device configured to disable or restrict movement of an underwater threat.

Still even yet another embodiment provides such a system, wherein at least one of the floatation modules has a dual hull having a shape which, when viewed from above, is narrower on the lengthwise ends thereof than the width near the lengthwise center thereof.

A still even yet further embodiment provides such a system, further comprising a plurality of energy sources, provided on at least some of the plurality of floatation modules, configured to provide energy to respective deploying/retracting mechanisms.

Yet still even another embodiment provides such a system, wherein the tendons are selected from the group consisting of straps, webbing, and sheets of polymeric or fabric-based materials, configured to distribute forces evenly and enhance controlled deployment.

A yet still even further embodiment provides such a system, further comprising a sensor.

A yet still even further still embodiment provides such a system, further comprising an automated deployment mechanism to deploy the deployable member in response to a signal from the sensor.

Another further embodiment provides such a system, further comprising a local control system configured to provide local control a deploying/retracting mechanism, mounted on the floatation module, based on an input through manual control that is a direct physical actuation or a user-initiated electronic command; an automated pre-programmed sequence that is a time-based schedule, a pre-set deployment pattern, or a condition-based automatic routine; remote activation based on a wireless signal, a radio-frequency (RF) control, a satellite communication, an internet-based command, or activation via a mobile or networked control interface; a sensor-triggered operation, based on input from one or more sensors selected from environmental sensors; proximity sensors; biological or chemical sensors; mechanical load or strain sensors; electromagnetic sensors; acoustic sensors; RFID readers; magnetic profile identifiers; optical identifiers; GPS or geofencing-based triggers, where deployment occurs when the system enters or exits a predefined geographic area; machine-learning-based adaptive control, wherein a control algorithm adjusts actuation based on historical data, operational trends, or AI-based predictive analytics; or an emergency or fail-safe trigger that is a mechanical override, an emergency stop mechanism; or an automatic retraction input in response to a system failure, a power loss, an unauthorized access detection, or an external override signals.

Another yet further embodiment provides such a system, further comprising a centralized control system configured to provide centralized control of some or all of a plurality of the deploying/retracting mechanisms, mounted on respective floatation modules, based on an input through manual control that is a direct physical actuation or a user-initiated electronic command; an automated pre-programmed sequence that is a time-based schedule, a pre-set deployment pattern, or a condition-based automatic routine; remote activation based on a wireless signal, a radio-frequency (RF) control, a satellite communication, an internet-based command, or activation via a mobile or networked control interface; a sensor-triggered operation, based on input from one or more sensors selected from environmental sensors; proximity sensors; biological or chemical sensors; mechanical load or strain sensors; electromagnetic sensors; acoustic sensors; RFID readers; magnetic profile identifiers; optical identifiers; GPS or geofencing-based triggers, where deployment occurs when the system enters or exits a predefined geographic area; machine-learning-based adaptive control, wherein a control algorithm adjusts actuation based on historical data, operational trends, or AI-based predictive analytics; or an emergency or fail-safe trigger that is a mechanical override, an emergency stop mechanism; or an automatic retraction input in response to a system failure, a power loss, an unauthorized access detection, or an external override signals.

Still another further embodiment provides such a system, further comprising an access controller, configured to retract the deployable member when an authorized vessel or underwater object is detected via sonar, RFID, magnetic identification, or optical recognition.

Another still further embodiment provides such a system, wherein the deployable member is configured as an aquaculture support structure; the retracted position is selected to facilitate harvesting and/or maintenance; and the deployed position is selected depending on an environmental condition to enhance growth rate of a marine species that is under cultivation.

Even another further embodiment provides such a system, wherein the system is configured to control the deployment length of the deployable member based on an environmental condition.

### BRIEF DESCRIPTION OF THE DRAWINGS

Detailed descriptions of various embodiments will be provided in the following sections, with reference to the accompanying drawings. In these drawings, similar reference numerals indicate corresponding elements. Please note that the drawings are not necessarily to scale, and in some instances, certain features may not be illustrated to facilitate a clearer understanding of the underlying concepts.

FIG. 1 is a perspective view of the modular maritime deployment system, configured as a marine barrier system, and major subcomponents thereof, in accordance with an embodiment, with the net retracted (stored) out of the water.

FIG. 2 is a side view of the modular maritime deployment system, configured as a marine barrier system of FIG. 1.

FIG. 3 is a top view of the modular maritime deployment system, configured as a marine barrier system, of FIG. 1.

FIG. 4 is a perspective view of a marine barrier system and major subcomponents thereof, in accordance with an embodiment, with the net deployed into the water.

FIG. 5 is a side view of the marine barrier system of FIG. 4.

FIG. 6A is an end view of a modular maritime deployment floatation module, in accordance with an embodiment, showing the net stored out of the water. FIG. 6B is an end view of a modular maritime deployment floatation module, in accordance with an embodiment, showing the net deployed.

FIG. 7A is a cross-sectional view of a modular maritime deployment floatation module in accordance with an embodiment, illustrating specifically how the net can be retracted and deployed.

FIG. 7B is a cross-sectional view depicting a modular maritime deployment floatation module in accordance with an embodiment, illustrating specifically how the net can be retracted and deployed with a single reel, dual tether configuration.

FIG. 8 is a sectional view depicting modular maritime deployment floatation modules in accordance with an embodiment, illustrating how the flotation modules may be interconnected.

FIG. 9 is an isometric view depicting compliant stanchions and accompanying equipment on a flotation module in accordance with an embodiment.

FIG. 10 is an isometric view depicting a modular maritime deployment system with an oil containment system deployed in accordance with an embodiment.

FIG. 11 is an isometric view depicting a modular maritime deployment system with a subsurface net with an interconnected oil boom in accordance with an embodiment.

FIG. 12 is a cross-sectional diagram depicting an example of how sensors can be integrated into a flotation module in accordance with an embodiment.

FIG. 13A is a cross-sectional diagram depicting how the same flotation module according to an embodiment can be used to deploy another counter UUV devices.

FIG. 13B is a cross-sectional diagram depicting how the same flotation module according to an embodiment can be used to deploy another counter UUV devices.

FIG. 14 is a side view depicting a marine barrier system in accordance with an embodiment, showing the subsurface net deployed from some flotation modules to block access to a non-friendly UUV and raised at other flotation modules to allow access to a friendly UUV.

FIG. 15 is a side view depicting a subsurface net in a marine barrier system in accordance with an embodiment, where the net can be raised off the seafloor by the deployment system, providing access to friendly UUV's.

FIG. 16. is an isometric view depicting a subsurface partition in a marine barrier system in accordance with an embodiment, the subsurface partition comprising a hinged semirigid panel.

FIG. 17 is an isometric view depicting a modular maritime deployment system in accordance with an embodiment, configured as a marine species cultivation system.

FIG. 18 is a detailed view depicting a modular maritime deployment system in accordance with an embodiment, configured as a single growline marine species cultivation system.

FIG. 19. is an isometric view of the modular maritime deployment system in accordance with an embodiment, configured as a grid framework marine species cultivation system.

### DETAILED DESCRIPTION

It should be noted that the principles outlined here are not confined to the specific details of construction or the arrangement of components as described in the following sections or depicted in the accompanying figures. These principles can be applied in various other embodiments and implemented in different ways. Furthermore, the terminology and language used in this document are intended for descriptive purposes and should not be construed as limiting.

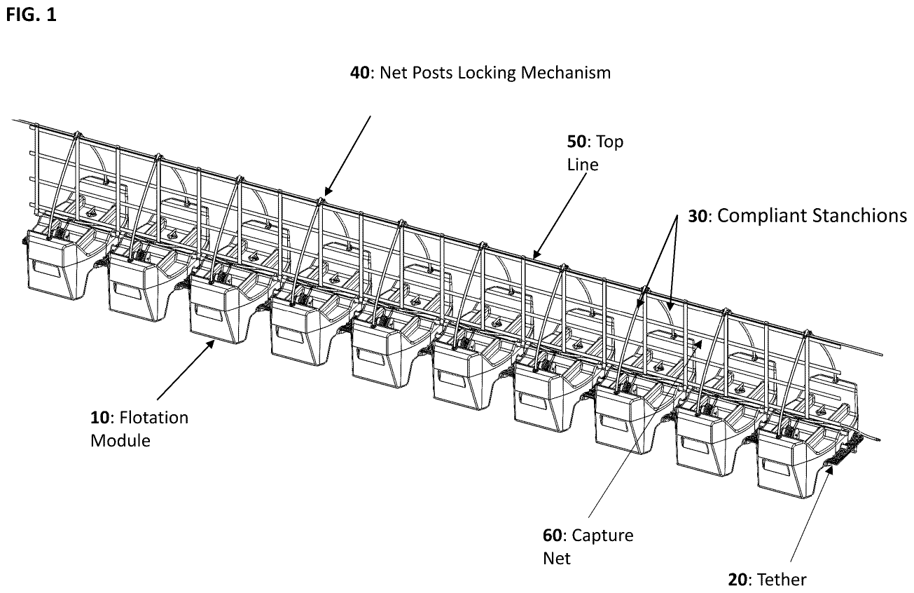

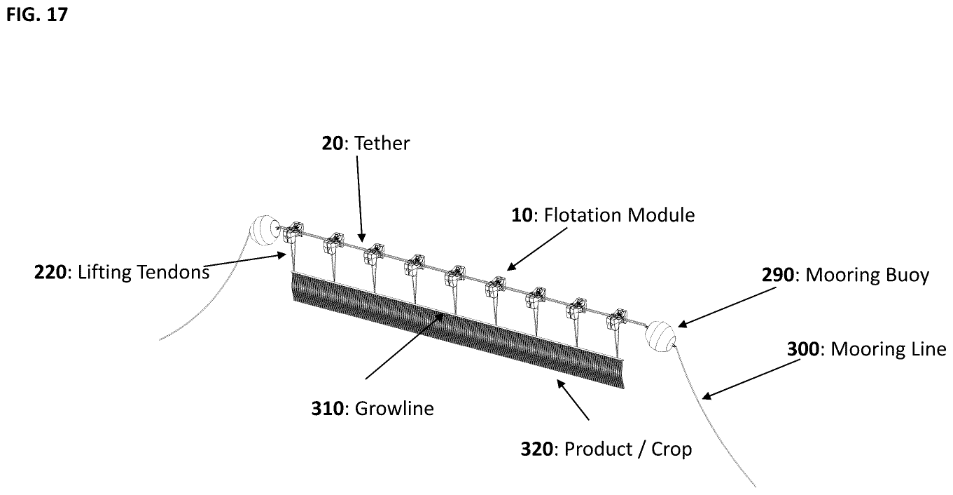

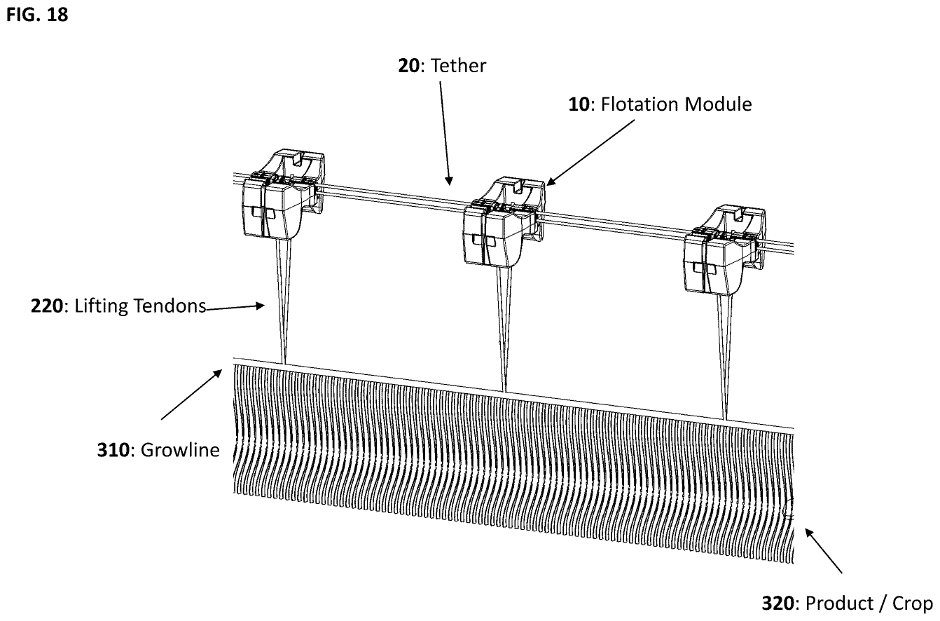

A detailed description of various embodiments of this disclosure will now be provided, with reference to FIGS. 1-19. FIGS. 1-16 illustrate a modular maritime deployment system that can function as a marine barrier and a deployable partition subsystem, designed for the protection of surface and subsurface assets. FIGS. 17-19 illustrate a modular maritime deployment system configured for use in marine species growth and cultivation.

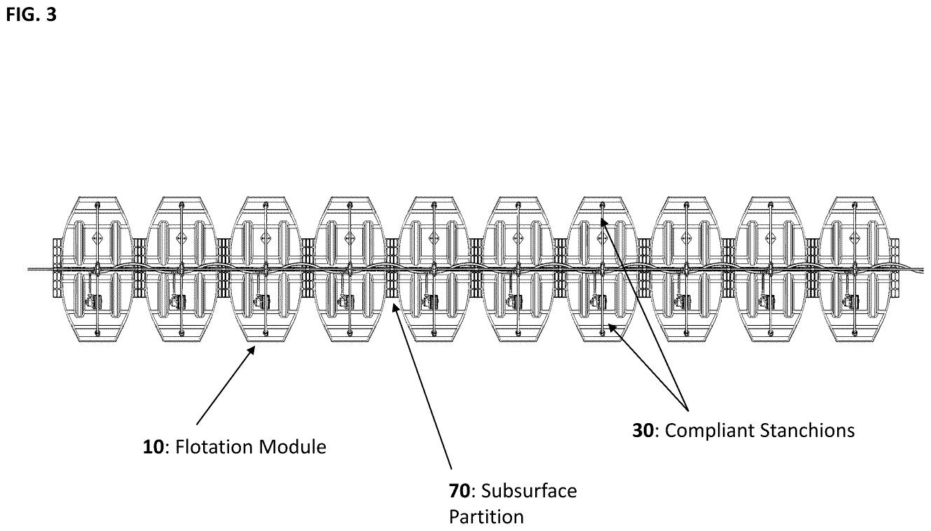

Referring to FIGS. 1-3, the floating barrier system that is an embodiment of a modular maritime deployment system comprises a series of dual-hull ‘catamaran’ type components, termed “flotation modules” 10 herein, which provide buoyancy and serve as barrier segments that are the structural foundation for the barrier system. These flotation modules 10 may be constructed from materials such as plastics, fiberglass, or metals, depending on the application requirements. As depicted in FIG. 3, the flotation modules 10 may have a shape which, when viewed from above, is narrower on the lengthwise ends thereof than the width near the lengthwise center thereof. Such a shape allows flexure of the barrier system without damage to the flotation modules 10, and prevents sharp corners in the flotation modules 10, minimizing the possibility of damage to the flotation modules 10 when there is contact therebetween.

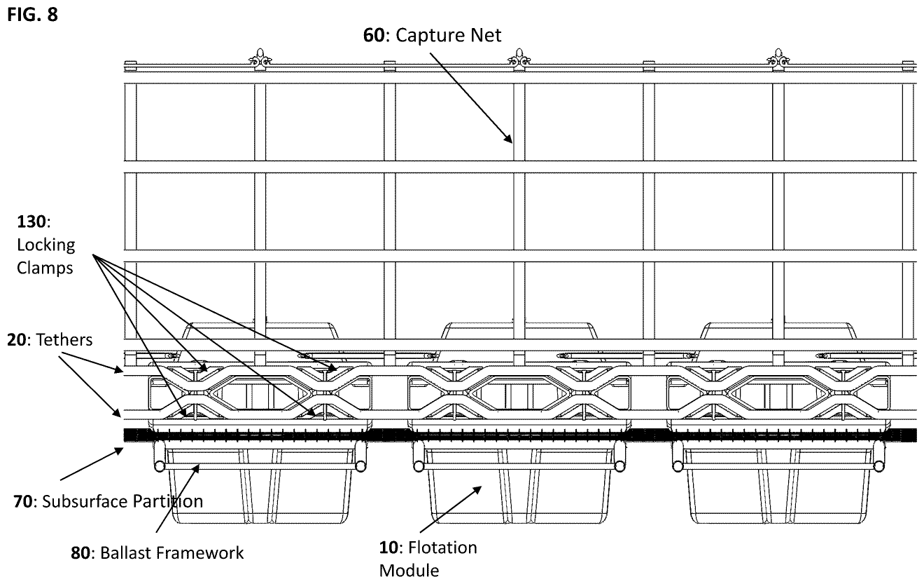

In embodiments, the flotation modules 10 are interconnected by dual tethers 20 which, in embodiments, are flexible. Positioned along the centerline of the barrier system, these dual tethers 20 ensure structural integrity and flexibility, allowing the barrier to adapt to water movements. In addition, such center-mounted dual tethers 20 allow the barrier to easily be swung open in the event access is required. In embodiments, the dual tethers 20 are continuous lines, ropes, wires, or cables that extend along the axial direction of the floating barrier system, with one of the tethers 20 lying above a portion of the flotation module 10 and the other tether 20 lying below a portion of the flotation module 10, with the flotation module 10 held therebetween. As depicted in FIG. 8, at intervals, the dual tethers 20, which hold the flotation modules 10 in place, are clamped together by locking clamps 130, thereby securing the flotation modules 10. Each of the dual tethers 20 may be a single continuous line across the entire barrier system, may be segmented by individual floatation modules 10 and connected together using standard marine junction hardware such as shackles (not shown), or may comprise segments that span multiple flotation modules 10 with breaks that are connected together detachably using standard marine junction hardware, so as to allow the barrier system to be opened to enable passage of surface traffic as required. Note that, in embodiments, adequate slack in the dual tethers 20 may allow for removal of the flotation module 10 that is held therebetween, thereby enabling replacement of a flotation module 10.

In embodiments, an above-water net capture system is mounted on the flotation modules 10 using dual compliant stanchions 30 that serve as flexible net posts for supporting a capture net 60, described below. Note that here a “net capture system” refers to a system that uses netting (hereinafter termed the “capture net 60”) that extends above the waterline to intercept surface vessels that attempt to breach the barrier. In embodiments the capture net 60 may comprise this flexible netting, while in other embodiments the capture net 60 may comprise a rigid or semirigid fencing material, where in the present disclosure the term “above-water net” is to be construed as including a fence. In embodiments, the net posts (compliant stanchions 30) are constructed of resilient materials and configured to bend under wave action or impact for enhanced stability and to reduce stress on the structure while maintaining the integrity of the above-water net or fence. The dual compliant stanchions 30 are engineered from compliant materials such as pultruded composite, fiber glass, or carbon fiber, enabling them to flex and twist under environmental forces. This design reduces stress on the net capture system, enhancing durability. The dual compliant stanchions 30 are mounted into the flotation modules 10 on the sides of the modules and are connected together with a stanchion locking mechanism 40 at the top of the structure. These dual compliant stanchions 30 are interconnected, along the axial direction of the barrier system, using a top line 50, comprising a rope, wire, cable, or the like, along the tops of the stanchions locking mechanisms 40. As with the dual tethers 20, this top line 50 may be a single continuous line across the entire barrier system, may be segmented by individual floatation modules 10 and connected together using standard marine junction hardware such as shackles (not shown), or may comprise segments that span multiple flotation modules 10 with breaks that are connected together detachably using standard marine junction hardware, so as to allow the barrier system to be opened to enable passage of surface traffic as required.

A capture net 60 is suspended between the top line 50 and the dual tethers 20, and is secured thereto through lashing, frapping, tying, use of standard hardware, shackles, grommets, pins, not illustrated, and not limited thereto. Note that the capture net 60 is designed so as to intercept a surface vessel that attempts to breach the barrier system, to thereby transfer the kinetic energy of the surface vessel through the capture net 60 to the dual tethers 20, which serve as the primary load-bearing members that ensure the integrity of the barrier system, and subsequently to the floatation modules 10, to ultimately be dispersed into the surrounding water. In embodiments, the capture net 60 may be made from polymers (fiber, nylon, polyester, polyethylene, etc.), metals (stainless steel), or from twines that are round or flat. In embodiments the capture net 60 may be structured from mutually intersecting strap-like materials or webbing. In embodiments the intersecting strap like materials may be loosely woven and/or secured at the intersections through sewing, stapling, riveting, adhesives, or other known methods for securing materials together.

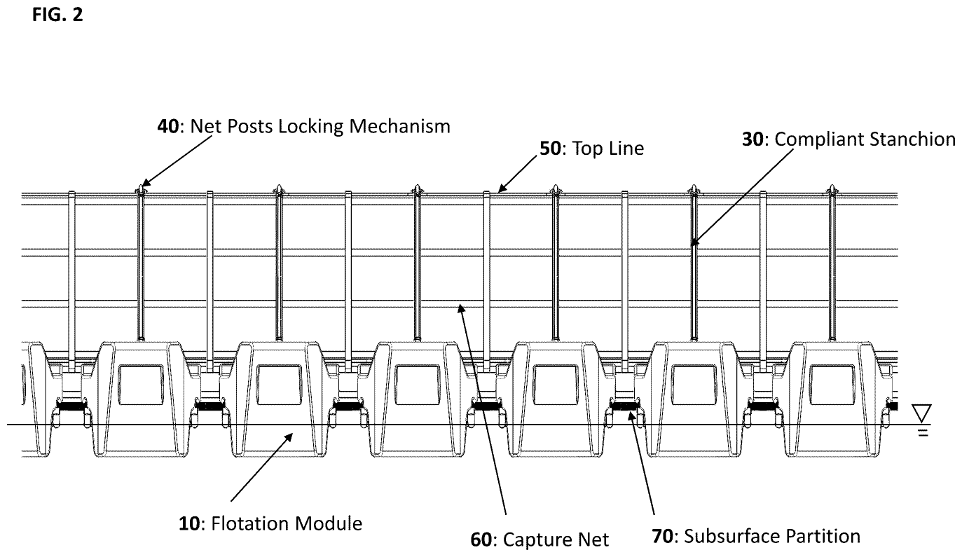

A subsurface partition 70, which is an example of a deployable barrier member, may be provided. In embodiments, the subsurface partition 70 may be a subsurface net, and may comprise polymer, monofilament, fiber optic, or metallic materials, and may be configured to intercept underwater threats such as UUVs, fish, jellyfish, and sharks. The storage location of the stowed subsurface partition 70 of one embodiment can be seen in FIG. 2. In this embodiment, the subsurface partition 70 is configured as a net, and is stored above water when not in use, significantly reducing maintenance and cleaning requirements. Such a design also minimizes the impact on marine wildlife and the surrounding ecosystem. In embodiments each flotation module 10 carries a corresponding segment of the subsurface partition 70. In embodiments, the edges of adjacent subsurface partitions 70 may be connected to each other through known methods to form a single continuous subsurface partition 70. In other embodiments, a single continuous subsurface partition 70 may be provided spanning multiple flotation modules 10. In other embodiments, the subsurface partition 70 may be provided in segments that span multiple flotation modules 10, with an opening portion (not shown) where edges of adjacent subsurface partitions 70 are not connected to each other, to thereby enable the barrier system to be opened to allow passage of surface or subsurface traffic. In embodiments two subsurface partition 70 segments may be disposed overlapping each other at said opening portion, to prevent a gap in coverage. In embodiments the subsurface partition 70 may be made from a variety of netting materials, including standard polymer nets, monofilament nets, and metal nets like stainless steel, allowing for customization based on specific security needs. In embodiments, the subsurface partition 70 may be of any of variety of net constructions (diamond mesh, square mesh, expanded metals, etc.). In embodiments the subsurface partition 70 may be made from an inexpensive material that stretches and entangles while being resistant to tearing, dissolving, and cutting, such as HDPE snow netting. In embodiments the subsurface partition 70 may comprise a net of a mesh structure that is fine enough to interdict small UUVs, with a mesh size of 3 inches or less. In the stored state, depicted in FIG. 2, the subsurface partition 70 may be in an accordion-folded state, supported by the ballast framework 80, described below. In embodiments, as described below, the subsurface partition 70 may comprise semirigid panels 270 instead of a net material.

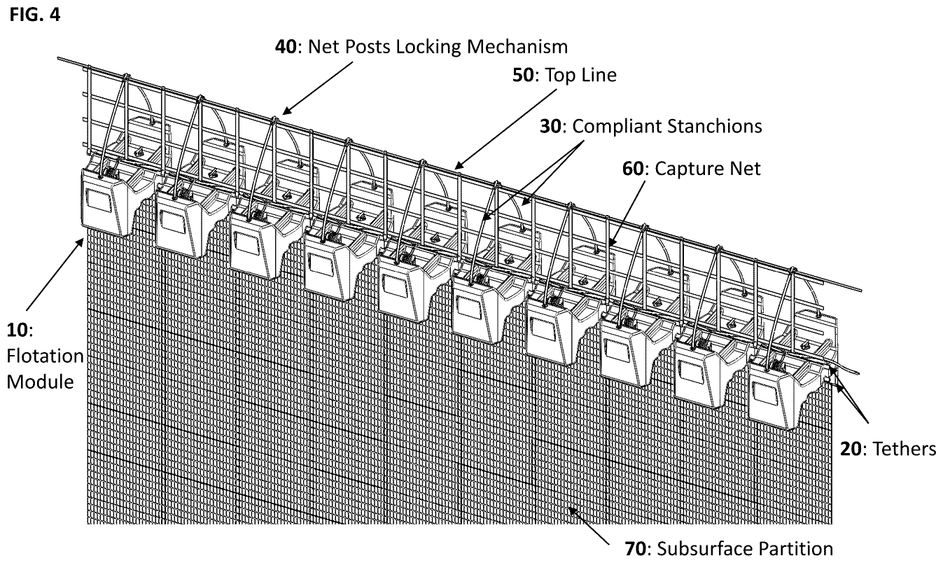

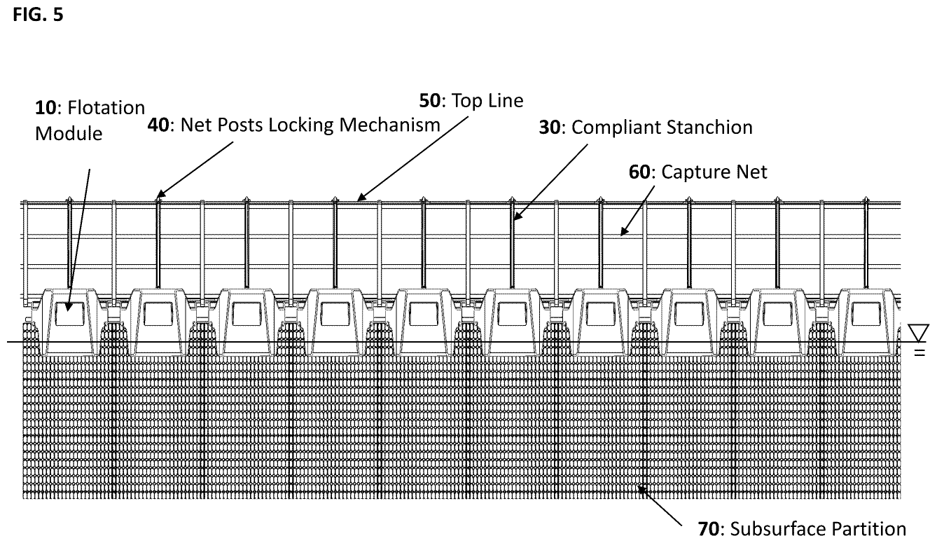

FIGS. 4 and 5 illustrate an embodiment wherein a modular maritime deployment system is configured as barrier system, with the subsurface partition 70 deployed, extending downward, where, in embodiments, the subsurface partition 70 extends to the seafloor. The subsurface partition 70 is an example of a deployable member. In embodiments the depth to which the subsurface partition 70 is deployed is adjustable, allowing the partition 70 to be used extending to a depth of several meters as an “anti-swimmer net” when needed. This is achieved by limiting the overall depth of the subsurface partition 70 or controlling the maximum extent to which the system lowers the subsurface partition 70. In other embodiments the subsurface partition 70 will extend to the seafloor, providing comprehensive subsurface protection. In embodiments a control system is provided that is configured to adjust automatically the deployed length or tension of the subsurface partition 70 in response to a bathymetry (underwater depth profile) and/or tidal condition, to thereby maintain effective barrier coverage despite water-level fluctuations or uneven seafloor depth. In embodiments, a portion of the subsurface partition 70 corresponding to one more specific floatation modules 10 may be raised either partially or fully out of the water while portions of the subsurface partition net 70 corresponding to other floatation modules 10 are left in place, thereby enabling opening of the marine barrier to facilitate access or passage through the subsurface partition net 70 while maintaining security against surface threats, permitting authorized vessels or marine life to pass through the subsurface partition net 70 at predetermined points while keeping the remainder of the subsurface partition net 70 deployed. The use of the subsurface partition 70 enhances the barrier's versatility, enabling it to adapt to various security requirements and environmental conditions. In embodiments, the length of the subsurface partitions 70 that are mounted on the individual floatation modules 10 are selected depending on the depth of the seafloor, or the like, over which the flotation module 10 is deployed or is anticipated to be deployed, thus enabling the contour of the bottom edge of the subsurface partition 70 system to conform roughly to the contour of the seafloor. Note that here “seafloor” should be interpreted to include similar concepts such as “river bottom” and “lake bottom,” depending on the applicable installation context.

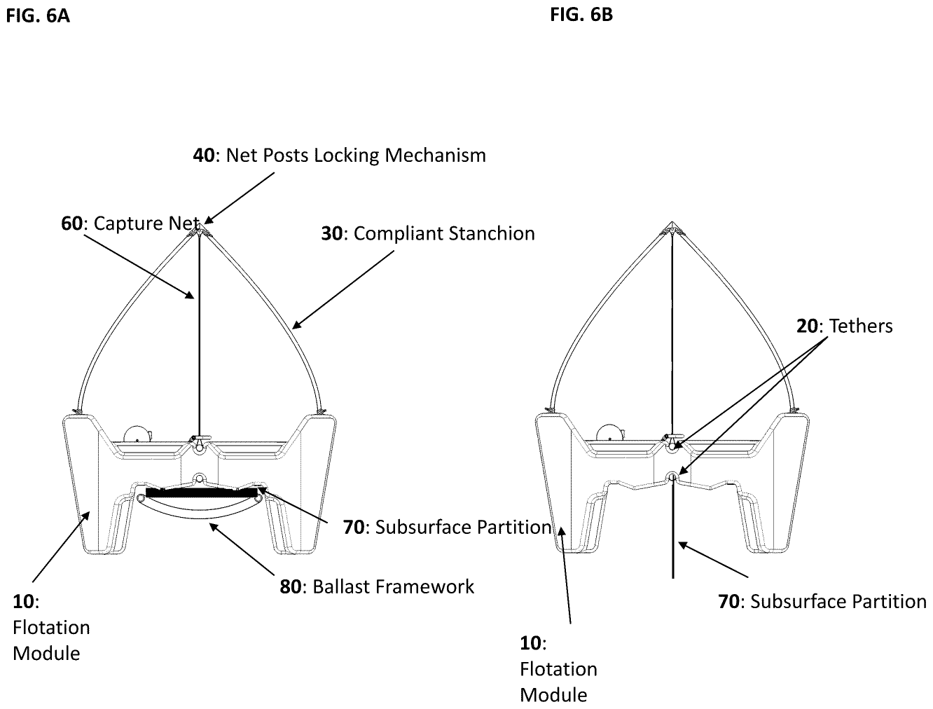

FIGS. 6A and 6B depict end views of floatation modules 10. As depicted in FIG. 6A and FIG. 6B, in embodiments each floatation module 10 may be configured with a hull shape designed for enhanced stability and deployment efficiency, the shape comprising a dual-hull or narrow-profile configuration that increases buoyancy stability and facilitates easy rotation or maneuvering of the module during deploying/retracting of the barrier member. FIGS. 6A and 6B depict the floatation modules 10 with the subsurface partition 70 stored and deployed, respectively. A ballast framework 80 is provided, connected to the subsurface partition 70 at what, in the deployed state, will be the bottom edge thereof. The ballast framework 80 is connected to the edge of the subsurface partition 70 through lashing or through standard or custom hardware, not illustrated. The ballast framework 80 ensures the descent of the subsurface partition 70 into the water by providing the necessary negative vertical force. In embodiments this ballast framework 80 comprises a system of fabricated tubes, while in other embodiments this ballast framework 80 comprises simple weights, whereas in other embodiments a chain, made from a heavy material such as a metal with a specific gravity in excess of one, may be used for the ballast framework 80. In embodiments this ballast framework 80 also supports the subsurface partition 70 when the subsurface partition 70 is stored out of the water, and may be constructed from materials such as, for example, plastic, metal, or composite. In embodiments, the top edge of the subsurface partition 70 is connected to the bottom line of the dual tethers 20 through known methods as described above. When the subsurface partition 70 is deployed, as seen in FIG. 6B, the load is transferred to the dual tethers 20, which serve as the primary load-bearing members, ensuring that the flotation module 10 is not subjected to significant tensile loading. The ballast framework 80 may have, on the bottom thereof, a mooring anchor of, for example, a pyramidal shape, enabling anchoring to the seafloor, or the like, when the subsurface partition 70 is deployed.

In embodiments, deployment of the subsurface partition 70 can be achieved using various standard marine equipment, such as winches (electrical or pneumatic), emergency releases, quick disconnects, exploding bolts, actuators, or manual methods. These subsystems can be integrated into the flotation module 10 to enable controlled deployment or retrieval. Those with ordinary skill in the art will appreciate that any of these types of subsystems can be added to the system to deploy (or deploy and recover, depending upon the subsystem) a deployable member, such as the subsurface partition 70, and can be mounted on the flotation module 10. In embodiments that include winches 90, the power (electrical or pneumatic) that is supplied to the winches 90 may be supplied through cables and/or pneumatic lines (such as the air system 10) provided in the barrier system. As with the dual tethers 20, these cables and/or pneumatic lines may be continuous across the entire barrier system, may be segmented by individual barrier module and connected together using standard or custom connectors (not shown), or may comprise segments that span multiple flotation modules 10 with breaks that are connected together detachably using connectors, so as to allow the barrier system to be opened to enable passage of surface traffic as required. In embodiments these cables or lines for powering the winches may also be used as, for example, the top line 50, or as part of the dual tethers 20, thereby reducing system costs.

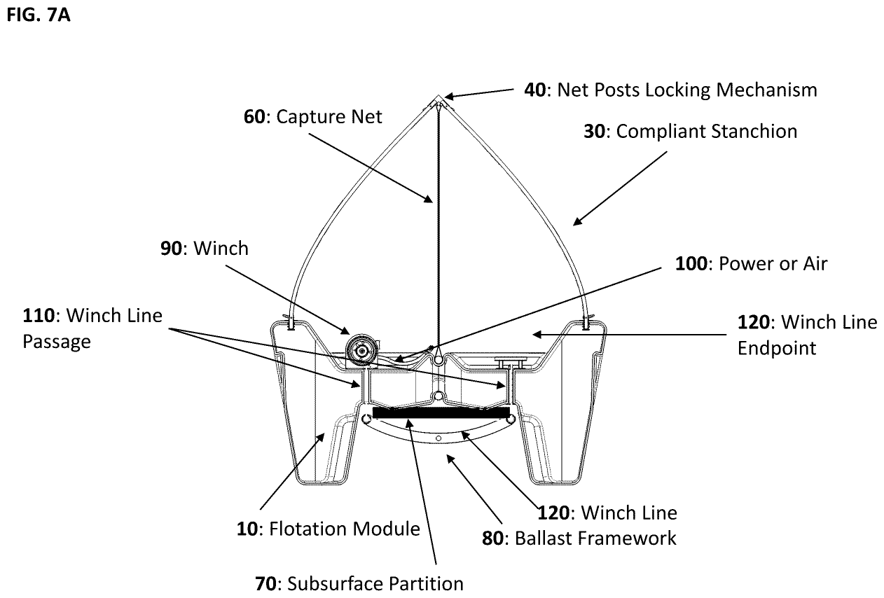

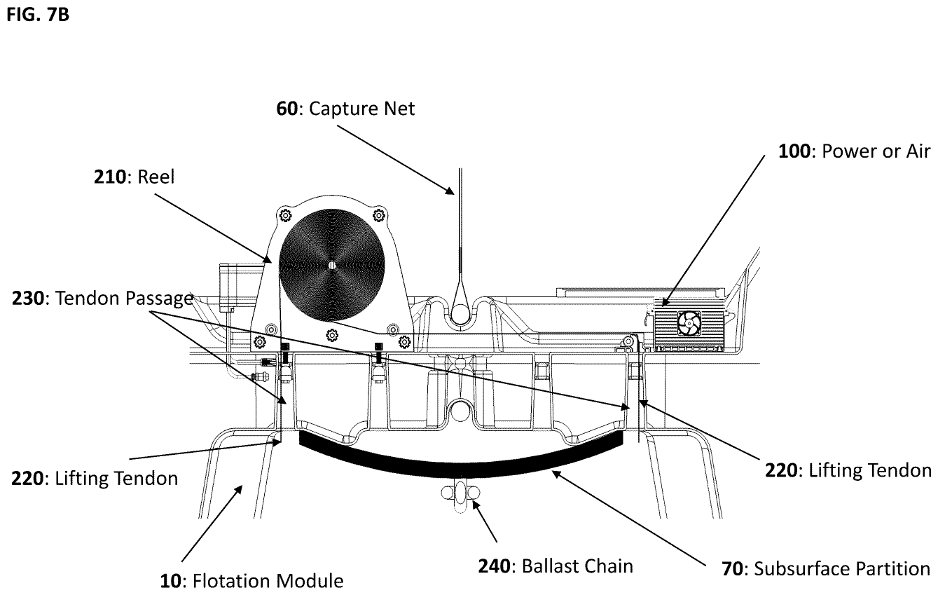

FIG. 7A provides a sectional view of a system for deploying/recovering the subsurface partition 70, a system that includes a winch 90, which is one example of a deployment mechanism. In embodiments the winch 90 may be a commercial off-the-shelf winch 90 and may be mounted on the flotation module 10, with power or pneumatic lines 100 running the length of the barrier system to supply the necessary energy for operation. In embodiments each individual floatation module 10 is equipped with a respective winch 90. As depicted in FIG. 7A, in each individual floatation module 10, a winch line 140 runs through the flotation module 10 at a first winch line passage 110, around the ballast framework 80, and back through a second winch line passage 110, where it is secured to a winch line endpoint 120. When the winch 90 pays out, the ballast framework 80 lowers, allowing the subsurface partition 70 to expand through the water column. During recovery, the winch 90 hauls the winch line 140 in, collapsing the subsurface partition 70 against the framework until it is securely stored below the flotation module 10. Given pre-creasing or hinging of the subsurface partition 70 in embodiments, the subsurface partition 70 may become accordion-folded automatically as it is recovered through the winch 90 hauling the winch line 140 in. In other embodiments, wherein the subsurface partition 70 comprises a flexible net, the subsurface partition 70 may be crushed and compressed randomly upon recovery. Once the subsurface partition 70 and ballast framework 80 are in place for storage, the winch 90 is stopped, and a brake or other standard winch locking mechanism, not shown, is engaged. During recovery of the subsurface partition 70, in embodiments the operation of winches 90 for the plurality of floatation modules 10 may be synchronized through sharing of a common pneumatic line 100, in what is inherently a self-stabilizing/self-synchronizing system.

FIG. 7B provides a sectional view of an embodiment of another system for deploying/recovering the subsurface partition 70 in an embodiment of a modular maritime deployment system, where the deploying/recovering system includes a reel 210. In embodiments the reel 210 may be a commercial off-the-shelf reel 210 and may be mounted on the flotation module 10, with power supplied locally or to adjacent units via battery and/or solar cells, where the batteries are solar cells are examples of energy sources in the present disclosure. In embodiments each individual floatation module 10 is equipped with a respective reel 210. As depicted in FIG. 7B, in each individual floatation module 10, a single, dual wrapped lifting tendon 220 runs through the flotation module 10 at a first winch line passage 110 or tendon passage 230, to the ballast chain 240. When the reel 210 pays out, the ballast chain 240 lowers, allowing the subsurface partition 70 to expand through the water column. During recovery, the reel 210 hauls the lifting tendons 220 in, collapsing the subsurface partition 70 against the framework until it is securely stored below the flotation module 10. Given pre-creasing or hinging of the subsurface partition 70 in embodiments, the subsurface partition 70 may become accordion-folded automatically as it is recovered through the reel 210 hauling the lifting tendons 220 in. In other embodiments, particularly those wherein the subsurface partition 70 comprises a flexible net, the subsurface partition 70 may be crushed and compressed randomly upon recovery. Once the subsurface partition 70 and ballast chain 240 are in place for storage, the reel 210 is stopped, and a brake or other standard reel locking mechanism, not shown, is engaged. During recovery of the subsurface partition 70, in embodiments the operations of reels 21 for a plurality of floatation modules 10 are synchronized through micro-processors or other standard or custom industrial control hardware.

Note that, in practice, the terms “winch” and “reel” can be used interchangeably, as can “winch line” and “lifting tendon,” the only difference being that, in the relevant art, “winches” and “winch lines” tend to apply to cases where the cross-sectional shape of the line that is wound onto the “winch” is circular, and cross-sectional shape of the “lifting tendon” that is wound onto the “reel” is elongate. While selection of terminology herein has been made for convenience to match the terms of the art, these terms are not intended to be limiting to any particular cross-sectional shape for the line or tendon, and the terms are intended to cover all cross-sectional shapes. In the present disclosure, both winches and reels are examples of deploying/retracting mechanisms. In embodiments the tendons 220 may be selected from the group consisting of straps, webbing, or other flat materials, each designed to distribute forces evenly and enhance controlled deployment. In embodiments the tendons 220 and winch lines 140 may be made from polyester, nylon, Kevlar, plastic coated aramid fibers, or the like.

FIG. 8 illustrates an axial sectional view of how the modules are interconnected. In embodiments, dual tethers 20 are fastened to the flotation modules 10 using locking clamps 130, which are made of, for example, plastic or metal. These clamps securely hold the tethers in place without external fasteners, enabling easy module replacement in the field.

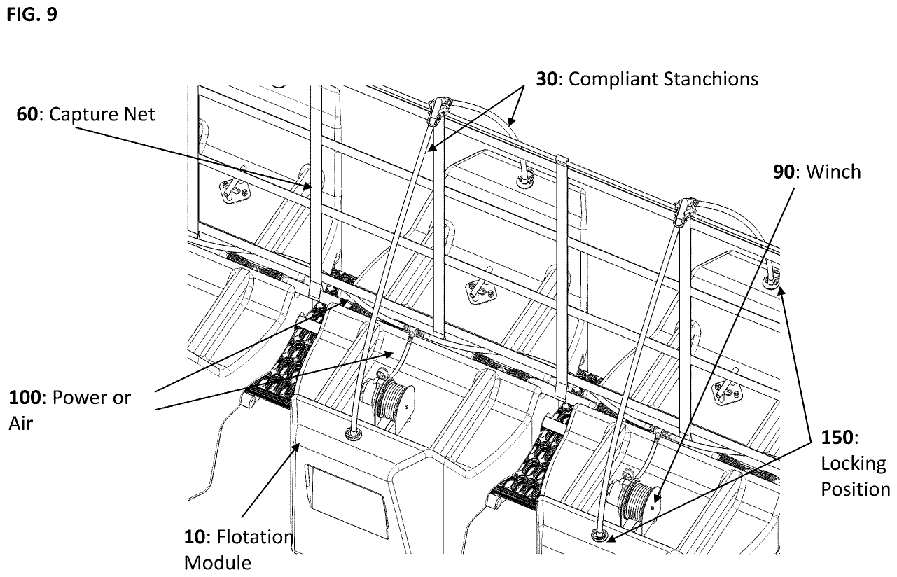

In FIG. 9, a detailed isometric view depicts secure attachment of the compliant stanchions 30 to the flotation module 10 at locking positions 150. The power or pneumatic line 100 that operates the winch 90 is also visible, spanning from one module to another.

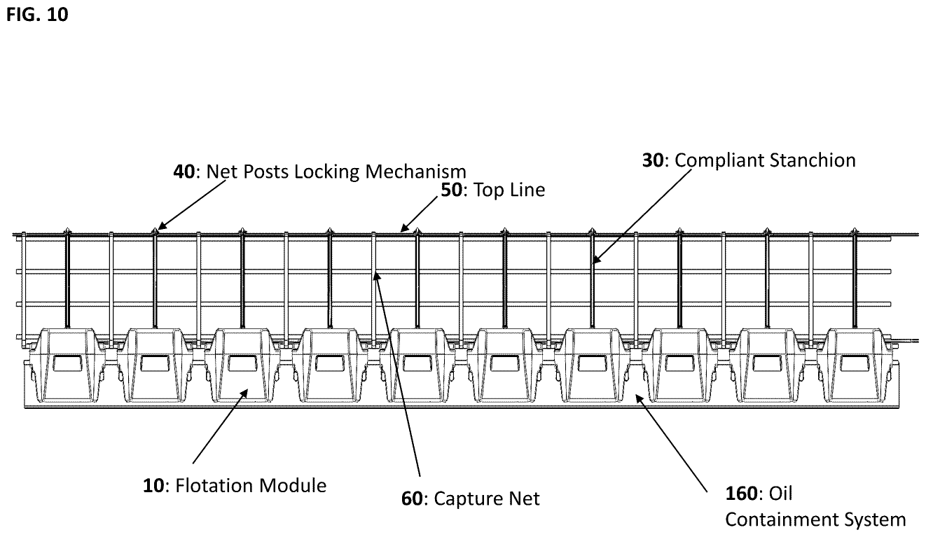

In embodiments as depicted in FIG. 10, the marine barrier system is configured as an environmental response system, providing protection through deploying an environmental response barrier. In embodiments this environmental response barrier may be an oil containment system 160, such as an oil boom. In other embodiments this environmental response barrier may be, for example, an exclusion net, such as a net to exclude from an area jellyfish, marine debris, or the like, a continuous containment boom, a debris boom or silt screen, or the like, or may comprise both a net (flexible or rigid) and another type of environmental response barrier, such as an oil containment boom, for multifunctional maritime security. The deployment and recovery mechanisms for this system may be achieved in the same manner as those described for the subsurface partition 70, discussed above, so redundant explanations are omitted. In embodiments the oil containment system 160 may be a standard commercial off-the-shelf oil boom designed for oil containment or abatement, and the depth and ballasting thereof may be tailored to the local environmental conditions. When not in use, the oil containment system 160 may be stored on the underside of the barrier above the waterline to minimize environmental impact and maintenance requirements, in the same manner as explained above for the subsurface partition 70.

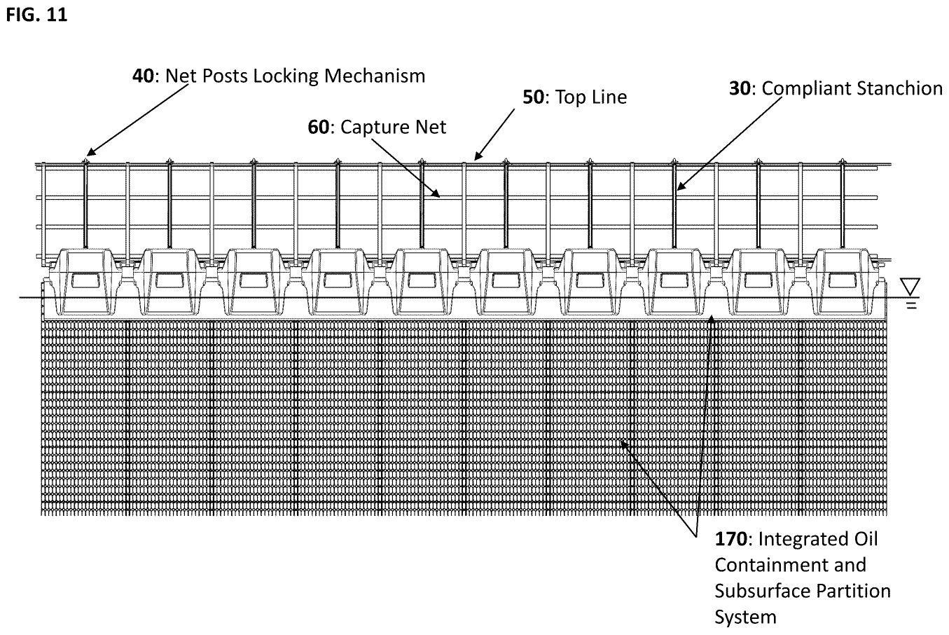

Further embodiments include an integrated oil containment and subsurface partition system 170 that combines an oil containment system 160 and the subsurface partition 70 as depicted in FIG. 11. In these embodiments, the upper 0.5-1.5 meters, for example, of the deployable subsurface barrier comprise an oil containment system 160, with a subsurface partition 70 comprising the remainder of the deployable subsurface subsystem. The oil containment system 160, the subsurface partition 70, and the integrated oil containment and subsurface partition system 170 are all examples of deployable members as referenced in the claims. The oil containment system 160 may comprise a foldable or collapsable oil boom. In embodiments this integrated oil containment and subsurface partition system 170, as was the case for the subsurface partition 70 described in embodiments above, is stored out of the water when inactive and deployed as needed, providing both environmental protection and security against underwater threats.

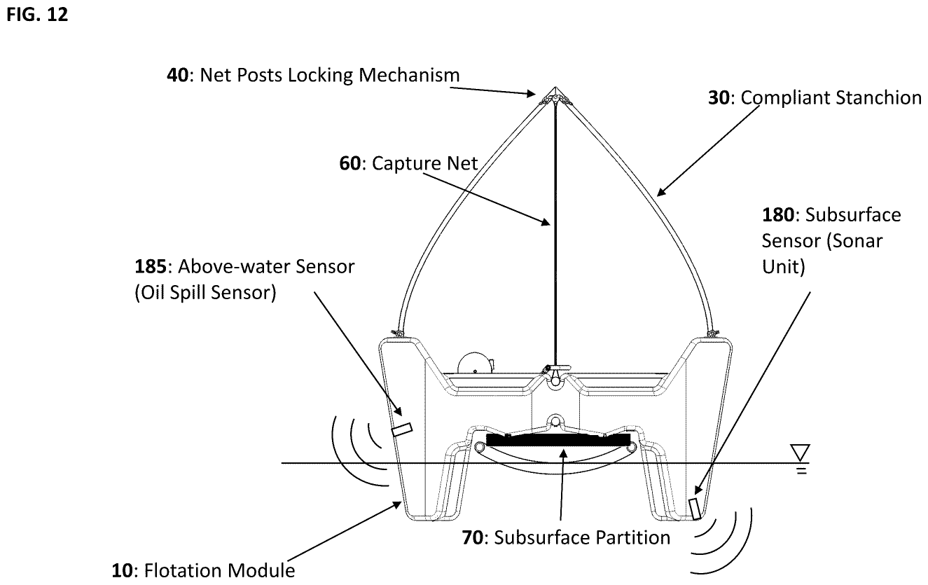

The deployment of the subsurface partition 70 and/or oil containment system 160 may be initiated on demand by security or environmental personnel or may be triggered automatically by a remote or integrated detection system comprising sensors such as hydrophones, sonar, or the like. In embodiments such sensors are integrated into the flotation modules 10 at strategic locations along the length of the barrier system to ensure optimal coverage, as depicted in FIG. 12. For example, in embodiments a subsurface sensor 180 is attached to the bottom of a flotation module 10 to monitor for UUVs or divers. The subsurface sensor 180 may be, for example, a sonar sensor, a hydrophone, a pressure sensor, a temperature sensor, a current sensor, a turbidity sensor, magnetometer, an acoustic doppler current profiler (ADCP), an acoustic doppler velocimeter (ADV), an optical sensor, an acoustic camera, an underwater acoustic positioning system, or any other sensor that can measure or identify a security or environmental threat that can be remediated through deployment of a subsurface partition 70 or some other deployable member such as entanglement lines, individual net panels, ballast components, and interdiction devices.

In embodiments, an above-water sensor 185, such as optical oil spill monitoring equipment, is mounted above the waterline on a flotation module 10 to detect oil spills and trigger the deployment of the oil containment system 160 as needed. In embodiments, the sensors 180 and 185 are able to communicate with a controlling device, not shown, either through a wired communication system, not shown, or wirelessly.

The subsurface partition 70 or the oil containment system 160, or other deployable member, may be deployed upon detection of a signal. In embodiments, the detection of the signal, causing deployment of the deployable member, may be detection of a signal from one or more of the sensors described above, or detection of a signal that is applied remotely from an external system, which may be triggered by an external sensor and/or a human operator. In embodiments, the signal may be a signal that is applied to a controlling subsystem (not shown) that controls powering of the deploying system such as, in embodiments that use a winch 90 or a reel 210, controlling the electrical or pneumatic power that is applied to the winch 90 or the reel 210. In some embodiments, the signal may be applied via a control cable, while in other embodiments the signal may be applied wirelessly, through an RF relay, an optical relay, an acoustic coupler, or the like.

In embodiments, power for the sensors and/or deployment mechanism (electric winches 90, air compressors, not illustrated, for driving pneumatic winches 90, or the like) may be provided from externally via a cable, with said cable running between the floatation modules 10. In other embodiments, each flotation module 10 may be provided with electrical power storage devices, such as batteries (not shown), for supplying the required power. In other embodiments electrical power storage devices may be shared between a plurality of floatation modules 10. In embodiments these electrical power storage devices may be supplied electrical power from solar cells, which may be mounted on some or all of the floatation modules 10, or on auxiliary floating platforms, not show. In other embodiments, the energy required for deployment of the deployable member may be stored as a compressed gas in a compressed gas cylinder to drive a pneumatic winch 90, as chemical energy for driving an explosive bolt, or some other non-electrical form.

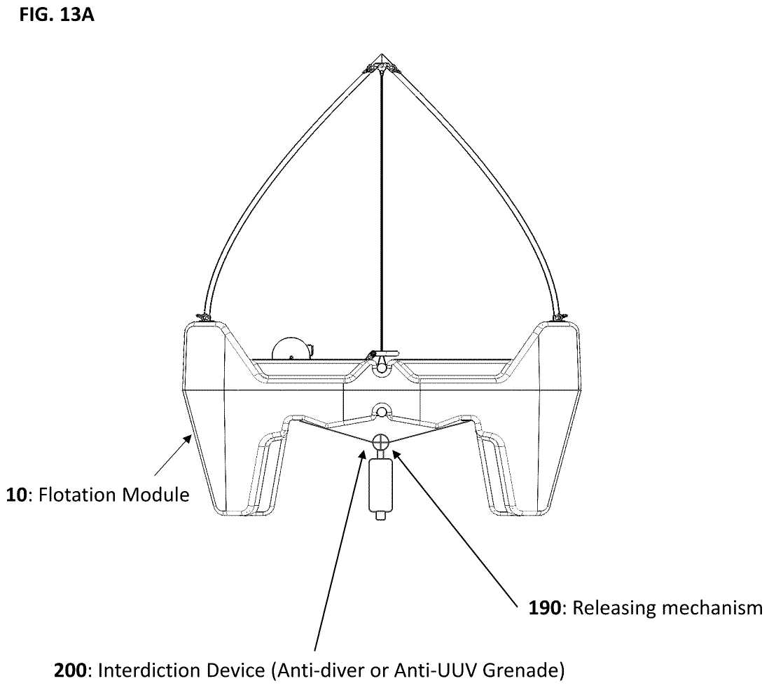

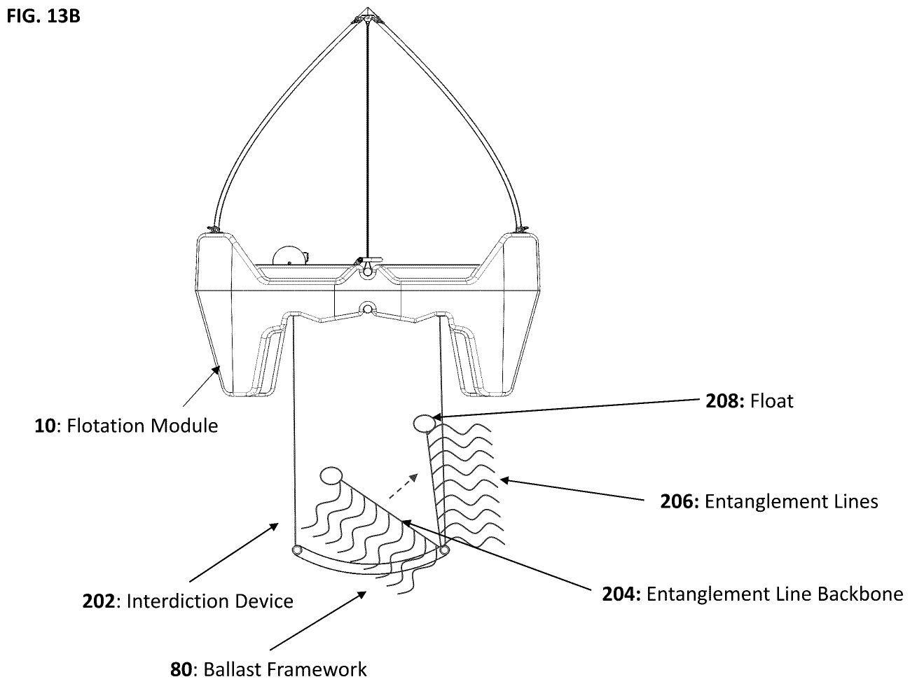

The system in the present disclosure is versatile in that it can be adapted to deploying other counter-UUV monitoring, capturing, or interdiction devices, as shown in the examples in FIG. 13A and FIG. 13B. In embodiments such as depicted in FIG. 13A, a releasing mechanism 190 may be provided to drop an interdiction device 200, which in the illustrated embodiment is an anti-diver or anti-UUV grenade, upon detection of threat by the sensor 180, described above.

In embodiments such as depicted in FIG. 13B, an interdiction device 202 may be deployed where, in embodiments, the interdiction device 202 may comprise the ballast framework 80, together with a plurality of entanglement line backbones 204 attached on one end thereto, with a plurality of entanglement lines 206 attached to each entanglement line backbone 204, as depicted. A float 208 is provided on the other end of each entanglement line backbone 204. Upon the subsurface sensor 180 depicted in FIG. 12, detecting a threat, the interdiction device 202 may be deployed, through control of the winch 90 or reel 210. As the negative-buoyancy ballast framework 80 descends towards the seafloor and the floats 208 provide positive buoyancy, the entanglement line backbones 204 are stretched therebetween, and the currents cause the entanglement lines 206 to spread out, causing an entanglement hazard for an incoming UUV. Upon entanglement of the propeller of the UUV with the entanglement lines 206, the winch 90 or reel 210 may then be controlled to retrieve the deployed interdiction device 202 along with the UUV that has been captured thereby.

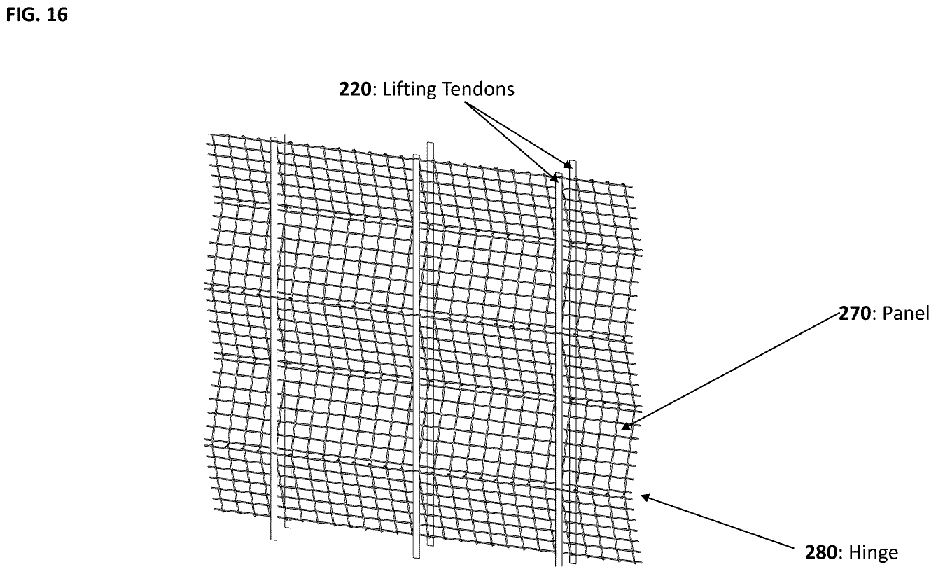

The same flotation modules 10 and motive equipment (such as winches 90) can be used not only for deploying and recovering subsurface partitions 70 and/or oil containment systems 160, but also for deploying other deployable members, such as, for example, interdiction systems or devices configured to disable or restrict movement of an underwater threat such as entanglement lines, net panels, ballasted/weighted components (to impair/impact UUVs), or anti-diver grenades, not illustrated, and for deploying, recovering, and controlling the depth of, other deployable systems, such as the aquaculture systems described below. In addition, as seen in FIG. 16, the deployable member may be a rigid, semirigid, or nonrigid member or panel 270 comprising an acoustic absorption material, an electro-magnetic shielding mesh, an energic reactive armor or non-energic reactive armor panels, or the like. In embodiments such rigid or semirigid panels 270 may be hinged together via hinges 280 to allow folding for storage when retracted. Depending on whether the capturing and interdiction devices require recovery, the system may utilize a one-time release mechanism, such as mechanical or electrical releases, explosive bolts, wire fusing releases, and the like, to release the ballast framework 80 and/or deployable member such as the subsurface partition 70.

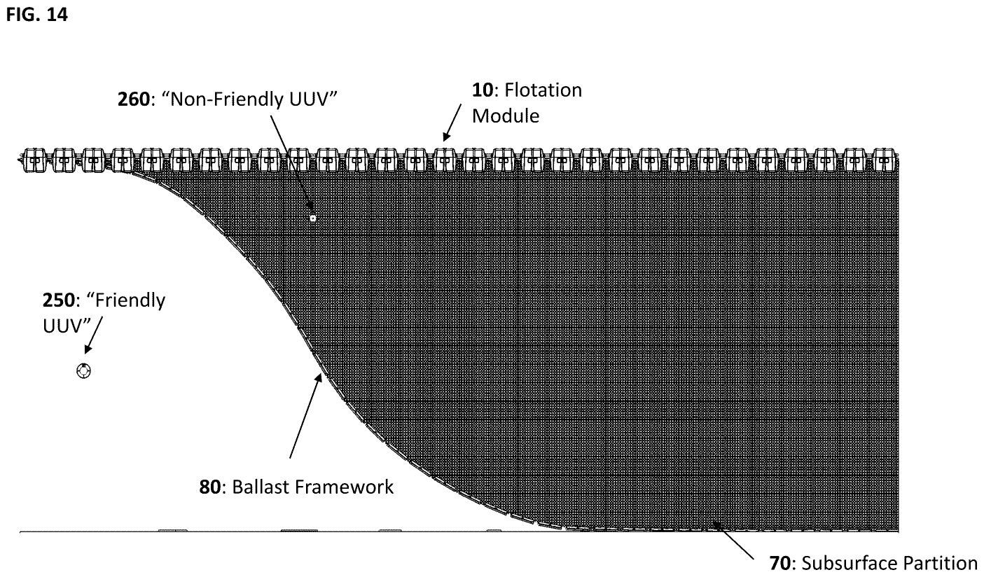

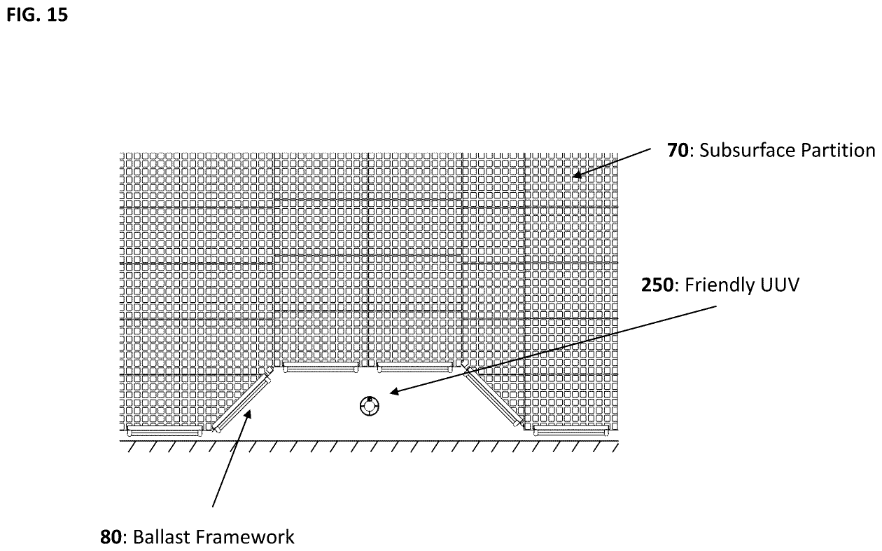

The ability to control a length or individual units within the modular maritime deployment system facilitates unique use cases for both security and commercial aquaculture operations. As depicted in FIGS. 14 and 15, deployment and recovery of the subsurface partition 70, either along its entire length (FIG. 14) or at one particular section along the system (FIG. 15), allows for the blockage of the water column to unfriendly UUVs 260 or access for friendly UUVs 250. This unique feature enables an unlimited number of customizable access points, sizes and spans for friendly vehicles or marine mammals, making the system adaptable for various operational environments. In embodiments the marine deployment system may comprise a control system, such as a microcontroller that is connected to a sensor (not shown), configured to adjust automatically a deployed length or a tension of the subsurface partition 70 in response to a change in bathymetry (underwater depth profile) and/or a tidal conditions, to thereby maintain effective barrier coverage despite water-level fluctuations or uneven seafloor depth. The sensor may be a tension sensor that senses the tension on a lifting tendon 220, to enable the system raise the subsurface partition 70 if tension on the lifting tendon 220 is reduced through the subsurface partition 70 resting on the ocean floor.

FIGS. 17-19 present a modular marine deployment system configured for use in growing and cultivating an aquaculture product or crop 320, or such as a macro-algae, a bivalve, shellfish or another algae, or kelp or any other aquaculture product or crop 320 that can be cultivated using a passive substrate. In such configurations, the flotation modules 10 may be spaced at set intervals, selected based on the weight/species of the product or crop 320 being grown or harvested. The depth of the growline 310 (an example of an aquaculture support structure configured to protect, support, and/or contain a marine species) or growline grid 330 may be adjusted dynamically via the lifting tendons 220 to achieve optimize growth rates, depending upon the species and depending on ambient conditions, and/or to simplify harvesting and maintenance operations.

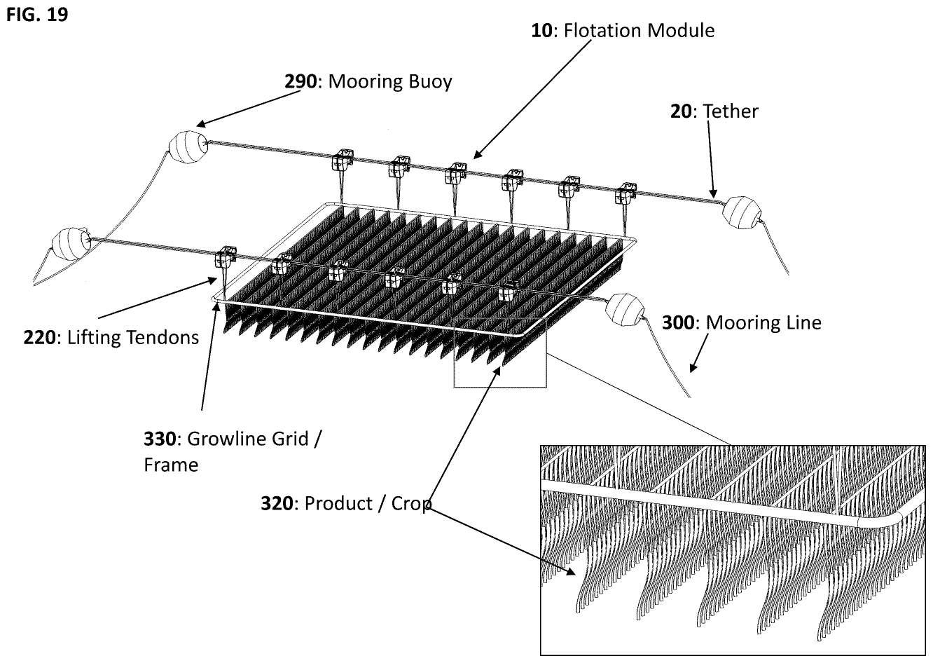

In embodiments, such as depicted in FIG. 19, a growline grid/frame 330 may be provided to provide support for multiple growlines 310 that are stretched thereacross, enabling an increase in cultivation area per floatation module. In embodiments, each flotation module 10 is equipped with solar panels, a battery, and micro-processing units (not shown) to facilitate adjustment of the depth of the growlines 310 or growline grid 330 in the water column, where deployment/retraction by the reels 21 on the respective floatation module 10 is synchronized and controlled through a central controller, not illustrated.

In embodiments, a central controller, not illustrated, for the system, for coordinating deployment and recovery of a deployable member, may perform control in response to, for example: manual control, including direct physical actuation or user-initiated electronic commands; automated pre-programmed sequences, including time-based schedules, pre-set deployment patterns, or condition-based automatic routines; remote activation, including wireless signals, radio-frequency (RF) control, satellite communication, internet-based commands, or activation via a mobile or networked control interface; sensor-triggered operation, based on input from one or more sensors selected from: environmental sensors (e.g., temperature, humidity, air or water pressure, wave height, wind speed, salinity, or tidal movement); proximity sensors (e.g., sonar, ultrasonic, infrared, LIDAR, radar, or camera-based motion detection); biological or chemical sensors (e.g., pH sensors, gas detectors, pollutant sensors, biological activity detectors); mechanical load or strain sensors (e.g., tension, compression, flexion, vibration, or impact sensors); electromagnetic sensors (e.g., magnetometers, electric field sensors, RF spectrum analyzers); acoustic sensors (e.g., hydrophones, microphones, or sonar-based triggers); RFID readers; magnetic profile identifiers; optical identifiers; GPS or geofencing-based triggers, where deployment occurs when the system enters or exits a predefined geographic area; machine-learning-based adaptive control, wherein a control algorithm adjusts actuation based on historical data, operational trends, or AI-based predictive analytics; emergency or fail-safe triggers, including mechanical overrides, emergency stop mechanisms, or automatic retraction in response to system failure, power loss, unauthorized access detection, or external override signals.

In embodiments, a local controller, not illustrated, for controlling deployment and/or recovery of a deployable member with respect to a single floatation module, may perform control in response to, for example: manual control, including direct physical actuation or user-initiated electronic commands; automated pre-programmed sequences, including time-based schedules, pre-set deployment patterns, or condition-based automatic routines; remote activation, including wireless signals, radio-frequency (RF) control, satellite communication, internet-based commands, or activation via a mobile or networked control interface; sensor-triggered operation, based on input from one or more sensors selected from: environmental sensors (e.g., temperature, humidity, air or water pressure, wave height, wind speed, salinity, or tidal movement); proximity sensors (e.g., sonar, ultrasonic, infrared, LIDAR, radar, or camera-based motion detection); biological or chemical sensors (e.g., pH sensors, gas detectors, pollutant sensors, biological activity detectors); mechanical load or strain sensors (e.g., tension, compression, flexion, vibration, or impact sensors); electromagnetic sensors (e.g., magnetometers, electric field sensors, RF spectrum analyzers); acoustic sensors (e.g., hydrophones, microphones, or sonar-based triggers); RFID readers; magnetic profile identifiers; optical identifiers; GPS or geofencing-based triggers, where deployment occurs when the system enters or exits a predefined geographic area; machine-learning-based adaptive control, wherein a control algorithm adjusts actuation based on historical data, operational trends, or AI-based predictive analytics; emergency or fail-safe triggers, including mechanical overrides, emergency stop mechanisms, or automatic retraction in response to system failure, power loss, unauthorized access detection, or external override signals.

In embodiments, an access controller may be provided configured to cause retraction of the deployable member when an authorized vessel or underwater object is detected via sonar, RFID, magnetic identification, or optical recognition, to thereby provide controlled passage. In embodiments the system is configured to control extension depth of the deployable member based on an environmental condition such as, for example, a bathymetric change, a current speed, detection of an object, a temperature, a lighting level, or detection of a chemical compound. Station-keeping of these systems may be achieved via standard mooring buoys 290 and mooring lines 300 and anchors (not shown).

In embodiments, a plurality of the flotation modules 10 and the subsurface partition 70 are arranged to form an expeditionary net pen 340 for marine mammals or other aquatic animals, such that when the subsurface partition 70 is deployed it creates an enclosed volume of water. This allows the system to serve as a temporary or portable marine enclosure, for example to contain or relocate marine mammals, with the ability to retract the subsurface partition 70 for moving or removing the enclosure as needed.

As would be appreciated by those skilled in the art of marine barrier systems, the barrier system outlined in this disclosure could have a variety of other configurations or embodiments not shown in the images. These include having a system that supports a permanently deployed net (i.e. where the net does not have the ability to be automatically deployed/recovered), a silt screen/debris boom (both with and without automation), as well as the ability to deploy a bubble screen to various depths through, for example the use of a ballast framework 80 that includes an airduct and air outlets, connected to an air source, where this airduct-including ballast framework 80 is an example of a bubble screen generator. All of these alternate deployable measures should be understood to be included within the definition of “deployable member” in the present disclosure. In embodiments these technologies are combined into the barrier system or the individual flotation modules 10 both to protect against UUV threats as well as to mitigate oil spills and contain other pollutants.

In embodiments a line (straight, arced, or curved) of floatation modules 10 may be arranged spanning across the mouth of a river, a bay, a harbor, or a recessed marine facility, or the like, secured by cables, or the like, to ground moorings on each side, and supplied power from at least one side. In other embodiments the floatation modules 10 may be moored between buoys. In other embodiments the floatation modules 10 may be arranged in a closed-loop configuration around an important marine asset, such as a bridge piling or a ship. In embodiments the closed-loop configuration may be secured through one or more buoys or other positioning mechanisms. While the line of floatation modules 10 constitutes an example of a series of floatation modules in the present disclosure, the series of floatation modules in the present disclosure is not limited thereto, but rather the floatation modules 10 may be arranged in any other formation, such as, for example, a lattice formation, a closed loop, or the like. These arrangements of a pluralities of floatation modules that are used to support deployable members constitute examples of floating support structures.

The barrier systems disclosed herein may be used for either exclusion or enclosure purposes.

The foregoing descriptions of embodiments of the invention has been presented for the purposes of illustration and description. Each and every page of this submission, and all contents thereof, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

In the present disclosure, the term “attached” may mean directly or indirectly attached, where an indirect attachment may be through movable or immovable components, or through a combination thereof.

What is claimed is:

1. A modular maritime deployment system comprising:
a plurality of flotation modules, each configured to provide buoyancy and structural support, connected together to form a floating support structure;
a deployable member, attached to at least one of the flotation modules, configured to be stowable in a retracted position and to be extendable downward into a deployed position; and
a deploying/retracting mechanism mounted on a flotation module, configured to control deployment and retraction of the deployable member between the retracted position and the deployed position; wherein
the deployed position in respect to the deploying/retracting mechanism is determined by a deployed length by which the deployable member is extended by that deploying/retracting mechanism or by the water column depth.

2. The system of claim 1, wherein the retracted position is such that at least a portion of the deployable member is above a waterline.

3. The system of claim 1, wherein the deploying/retracting mechanism comprises a reel configured to wind or unwind simultaneously dual tendons that are attached to the deployable member.

4. The system of claim 1, further comprising a dual tether, connecting at least some of the plurality of the flotation modules, secured to each of the connected floating modules using locking clamps.

5. The system of claim 1, further comprising a local control system configured to adjust automatically a deployed length or a tension of the deployable member in response to a bathymetry and/or tidal condition.

6. The system of claim 1, wherein the deployable member is a bubble screen generator.

7. The system of claim 1, wherein the deployable member comprises one or more selectively actuatable sections, wherein each section can be independently raised, lowered, or retracted.

8. The system of claim 1, wherein the deployable member is a deployable barrier member.

9. The system of claim 8, wherein the deployable barrier member is configured so as to be supported by the deploying/retracting mechanisms of a plurality of the flotation modules.

10. The system of claim 9, wherein the deployable barrier member is configured so as to enable a length of extension of one portion of the deployable barrier to differ from a length of extension of another portion of the deployable barrier member.

11. The system of claim 9, wherein the deployable barrier member is configured as an environmental response barrier.

12. The system of claim 9, wherein the deployable barrier member is configured as an expeditionary net pen.

13. The system of claim 1, further comprising a flexible net post, positioned on or atop an aforementioned flotation module, the net post extending upward and supporting an above-water net, wherein the net post comprises a resilient material and is configured to bend under wave action or impact.

14. The system of claim 1, wherein the deployable member comprises a ballast framework.

15. The system of claim 1, wherein the deployable member comprises an interdiction system or device configured to disable or restrict movement of an underwater threat.

16. The system of claim 1, wherein at least one of the floatation modules has a dual hull having a shape which, when viewed from above, is narrower on the lengthwise ends thereof than the width near the lengthwise center thereof.

17. The system of claim 1, further comprising a plurality of energy sources, provided on at least some of the plurality of floatation modules, configured to provide energy to respective deploying/retracting mechanisms.

18. The system of claim 3, wherein the tendons are selected from the group consisting of straps, webbing, and sheets of polymeric or fabric-based materials, configured to distribute forces evenly and enhance controlled deployment.

19. The system of claim 1, further comprising a sensor.

20. The system of claim 19, further comprising an automated deployment mechanism to deploy the deployable member in response to a signal from the sensor.

21. The system of claim 1, further comprising a local control system configured to provide local control a deploying/retracting mechanism, mounted on the floatation module, based on: an input through manual control that is a direct physical actuation or a user-initiated electronic command; an automated pre-programmed sequence that is a time-based schedule, a pre-set deployment pattern, or a condition-based automatic routine; remote activation based on a wireless signal, a radio-frequency (RF) control, a satellite communication, an internet-based command, or activation via a mobile or networked control interface; a sensor-triggered operation, based on input from one or more sensors selected from: environmental sensors; proximity sensors; biological or chemical sensors; mechanical load or strain sensors; electromagnetic sensors; acoustic sensors; RFID readers; magnetic profile identifiers; optical identifiers; GPS or geofencing-based triggers, where deployment occurs when the system enters or exits a predefined geographic area; machine-learning-based adaptive control, wherein a control algorithm adjusts actuation based on historical data, operational trends, or AI-based predictive analytics; or an emergency or fail-safe trigger that is a mechanical override, an emergency stop mechanism; or an automatic retraction input in response to a system failure, a power loss, an unauthorized access detection, or an external override signals.

22. The system of claim 1, further comprising a centralized control system configured to provide centralized control of some or all of a plurality of the deploying/retracting mechanisms, mounted on respective floatation modules, based on: an input through manual control that is a direct physical actuation or a user-initiated electronic command; an automated pre-programmed sequence that is a time-based schedule, a pre-set deployment pattern, or a condition-based automatic routine; remote activation based on a wireless signal, a radio-frequency (RF) control, a satellite communication, an internet-based command, or activation via a mobile or networked control interface; a sensor-triggered operation, based on input from one or more sensors selected from: environmental sensors; proximity sensors; biological or chemical sensors; mechanical load or strain sensors; electromagnetic sensors; acoustic sensors; RFID readers; magnetic profile identifiers; optical identifiers; GPS or geofencing-based triggers, where deployment occurs when the system enters or exits a predefined geographic area; machine-learning-based adaptive control, wherein a control algorithm adjusts actuation based on historical data, operational trends, or AI-based predictive analytics; or an emergency or fail-safe trigger that is a mechanical override, an emergency stop mechanism; or an automatic retraction input in response to a system failure, a power loss, an unauthorized access detection, or an external override signals.

23. The system of claim 1, further comprising an access controller, configured to retract the deployable member when an authorized vessel or underwater object is detected via sonar, RFID, magnetic identification, or optical recognition.

24. The system of claim 1, wherein:
the deployable member is configured as an aquaculture support structure;
the retracted position is selected to facilitate harvesting and/or maintenance; and
the deployed position is selected depending on an environmental condition to enhance growth rate of a marine species that is under cultivation.

25. The system of claim 24, wherein the system is configured to control the deployment length of the deployable member based on an environmental condition.
